(19) United States
(12) Patent Application Publication
(10) Pub. No.: US 2008/0086406 A1
(43) Pub. Date: Apr. 10, 2008

(54) System and Method for Handling an Inquiry/Offer Process

(75) Inventor: Anders Gillmert, Bad Honnef (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 11/659,597

(22) PCT Filed: Sep. 8, 2005
(86) PCT No.: PCT/EP05/09631

§ 371 Date: Feb. 7, 2007

(30) Foreign Application Priority Data
Sep. 29, 2004 (DE) 10 2004 047 198.3

(51) Int. Cl. G06Q 30/00

(52) U.S. Cl. 705/37

(57) ABSTRACT

A system and method are disclosed for handling an inquiry/offer process for large components in electrical engineering. Exemplary embodiments can handle an inquiry/offer process for a potential customer and create a possibility of achieving a maximum number of providers and of making an inquiry/offer process more accurate.

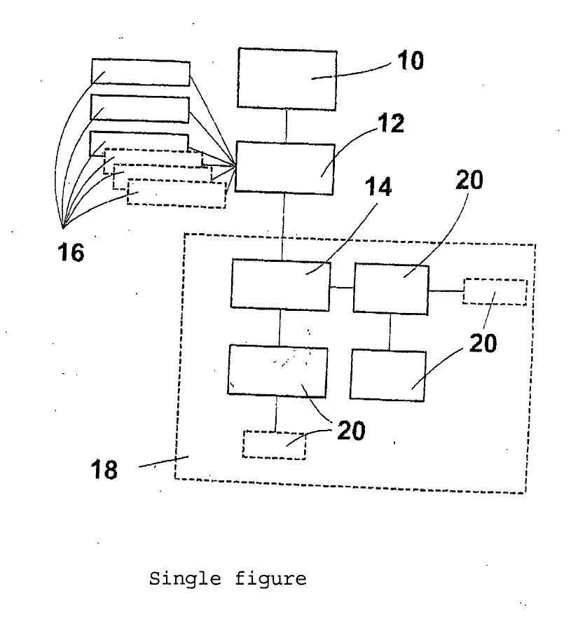

The invention relates to a system and method for handling an inquiry/offer process for large components in electrical engineering.

Large components in electrical engineering, in particular power transformers, are products which need to be described using comparatively detailed technical specifications such as the power to be transmitted, the power factor provided cos(phi) and features relating to equipment.

Such large components generally need to be procured for customer-specific, often unique requirements or technical boundary conditions, which results in the large components requested often being designed especially for an application case. A potential provider of such goods can therefore not simply offer a standardized product; rather, a potential customer will in this case generally request the desired properties of the product from the viewpoint of an inquirer in the form of an invitation to tender.

It may be the case here that important technical data for creating the offer are absent or the data specified are contradictory because the requested product is particularly sophisticated in technical terms or because whoever submits the invitation to tender does not have the same extensive knowledge of the product or the field as the manufacturers of the large components. The result is complicated correspondence in order to eliminate any unclear points.

In addition, the invitation to tender is generally only sent to the potential providers known to the customer and these providers are requested to provide an offer. One disadvantage here is the fact that the customer, for example, does not know all of the suppliers or cannot even take into account new suppliers owing to a lack of knowledge, and accordingly not every possible supplier is applied to.

In addition, in order to reduce the complexity of the invitation to tender, only the so-called preferred suppliers, or only some of the suppliers, are generally taken into account, which in turn prevents the breadth of the market from being fully used.

On the basis of this prior art, the object of the invention is to specify a system and a method of the type mentioned initially which makes it easier to handle an inquiry/offer process for the potential customer and in addition creates the possibility of achieving a maximum number of providers and of making the inquiry/offer process more secure.

The object is achieved by the system according to the invention for handling an inquiry/offer process for large components in electrical engineering having the features in accordance with claim 1.

Accordingly, an inquiry/offer webpage is set up on an Internet server of a first potential provider. The input data relating to the large component can be input into an input mask of the webpage by potential customers. The input data are saved in terms of data technology by the server and are made available for retrieval purposes. In addition, input data relating to selected large components can be retrieved by further or all of the potential providers and made available to the respective provider for processing purposes. In each case an offer can be created by the providers, and this offer can be transmitted to the potential customer.

One advantage is the fact that a particularly competent provider sets up the inquiry/offer webpage. This makes it possible for the manufacturer producing the large components being requested, i.e. having a correspondingly good product knowledge, to establish the input data required for creating the offer. Possible unclear points or contradictory technical specifications are accordingly ruled out or at least considerably reduced. Furthermore, possible mistakes, erroneous copies, etc., as may generally occur, and leading to different versions of offer documents, are avoided. The inquiry/offer process is made more secure.

In addition, a potential customer only needs to generate input data once. Furthermore, the complex and time-consuming correspondence for procuring absent data or for clarifying contradictory data relating to the large components is dispensed with. The inquiry/offer process is therefore simplified for the potential customer.

In addition, the input data can be saved in terms of data technology and can be retrieved by all potential providers, i.e. even in particular by any competitor. The advantage for the potential customer lies in the fact that each potential provider has access to the same data. This is particularly the case when a provider expresses an interest in creating an offer. All providers which have a serious interest in creating an offer are thus reached, and at the same time the potential customer is prevented from sending an inquiry to providers which possibly have no desire to, or cannot, provide an offer in response to the specific inquiry. Even providers which are new on the market and which the potential customer perhaps does not yet know can have access to the input data and create an offer. The maximum number of providers can therefore be achieved.

A further advantage is the immediate availability of the input data once they have been saved in terms of data technology. The inquiry/offer process can be handled more quickly. Accordingly, the overall inquiry/offer process is simplified and improved.

In one advantageous refinement of the system according to the invention, the input data can be retrieved by means of a data processing device connected to the intranet of the first provider.

Owing to this possibility of retrieving data using the data processing system, the input data are advantageously available in the entire intranet of the first provider. All interested parties with access to the intranet can thus gain access to the input data. This is of particular advantage when, as is often the case with the manufacturers of large components, the sales unit is located in a completely different town or country or continent from the relevant production site.

In one advantageous development of the method according to the invention, the input data are analysed by means of a data processing device connected to the provider intranet, and possibly at least one large component matching the inquiry is selected. With this refinement, the advantage lies in the time saved owing to the particularly quick assignment of the appropriate product of the large component to be provided to the input data.

In a further refinement of the system according to the invention, the product data associated with the respective large component to be offered can be passed to a receiver provided for the purpose of creating an offer.

In this case, an improvement of the handling of the inquiry/offer process is further provided by the time saving. With the product data being automatically passed to a receiver which creates the offer, a further error source, namely the otherwise conventional individual selection of product types, is also avoided.

A considerable improvement of the inquiry/offer process is brought about when, in the case of the system according to the invention, the offer can be created automatically by the receiver. In this case, a possible error source is again avoided and, in addition, the process time is further reduced.

In accordance with the system according to the invention, an offer can be created in an advantageous and rapid manner which is characterized by the fact that the offer can be passed to the potential customer.

Finally, the inquiry/offer process is designed to have optimum speed and reliability. The possibility of errors being caused by the party creating the offer is also now avoided.

In addition, the object is achieved by the method according to the invention for handling an inquiry/offer process for large components in electrical engineering having the features in accordance with claim 13.

Accordingly, an inquiry/offer webpage is set up on an Internet server of a first potential provider. The input data relating to the large components are input into an input mask of the webpage by potential customers. The input data are saved in terms of data technology by the server and are made available for retrieval purposes. In addition, input data relating to selected large components are retrieved by further or all of the potential providers and made available to the respective provider for processing purposes. In each case an offer is created by the providers, and this offer is transmitted to the potential customer.

There are the same advantages as have already been described in relation to the system according to the invention.

Further advantageous refinements of the subject matter of the invention are described in the dependent claims.

In the drawing:

the single FIGURE shows a flowchart of an inquiry/offer process.

As an example of a preferred method sequence according to the invention, the single FIGURE shows a flowchart in which a customer who wishes to order a power transformer has access to an offer webpage on an Internet server 12 using a data processing system 10, i.e. can exchange data with said offer webpage. In addition to a first computer 14 of a first potential provider, further computers 16 of further possible providers can have access to this offer webpage.

The first computer 14 is also part of an intranet 18 and can accordingly exchange data with other intranet computers 20.

A configuration of the system and method according to the invention will be explained in more detail using the example of the network design in accordance with the single FIGURE. Initially, the first provider will set up an offer webpage on the Internet server 12, in this example for the purpose of inquiring about a power transformer.

An inquirer will access the webpage 12 by means of the data processing system 10, this webpage 12 having been set up for this purpose by a first provider in order to detect the data relating to the desired product and required for an inquiry or an offer as so-called input data. The input data are detected by means of an input mask which ensures that all of the data necessary for creating the offer are obtained. If a set of input data is detected, these data are stored by the Internet server 12 and made available for retrieval purposes.

It is easily conceivable for a fee to be imposed on the inquirer for the use of the offer webpage. This fee can be imposed automatically prior to or during inputting of the input data. In this case, all generally known online methods can be used. As an alternative to this, it may also be requested that merely an agreement be made to pay the fee. In this case, the fee is charged subsequently in the conventional manner to the inquirer, for example by an invoice being created.

Data can be retrieved by any computer which has access to the Internet server 12, i.e. not only by the first computer 14 of the first provider but, for example, also by all competitors via the further computers 16. The advantage for the inquirer lies in the fact that the input data are only required to be input once, in which case the inquirer can be sure that all of the providers obtain the same input data, and potential errors are avoided at this point.

However, it is also within the scope of the concept of the invention if the input data need to be released initially by the inquirer before they can be retrieved by any provider.

In one example, the input data are retrieved from the Internet server 12 by the first computer 14, which is located at a site A. The first computer 14 is set up for the purpose of analysing the input data of the inquiry and associates two or more appropriate products with these input data, a first product being produced at a site B, a second product at a site C, and a third product at a site D. The appropriate product data relating to the products are obtained by the first computer 14 by automatic inquiries at the relevant intranet computers 20 at the sites A to D (not all illustrated in the FIGURE).

The input data are sent together with the appropriate products and their product data to one of the intranet computers 20, which is located at the site D, and the offers are automatically sent to the first computer 14, which passes on the offer via the Internet to the potential customer. However, it is also easily conceivable for the intranet computer 20 which has created the offer to likewise have access to the Internet and for the offer to be sent directly to the potential customer.

Finally, statistics which provide information on the inquiry/offer process are formed. For example, statistics relating to preferably requested products, about customers or about the speed between the inquiry about and provision of the offer can be formed. This is because a comparatively large number of data are recorded in the inquiry/offer process according to the invention allowing a detailed evaluation.

1. System for handling an inquiry/offer process for large components in electrical engineering,
an inquiry/offer webpage being set up on an Internet server of a first potential provider,
the inquiry/offer webpage containing at least one input mask, it being possible for input data relating to a large component to be input into said input mask by potential customers,
the Intranet server being set up for the purpose of making input data available safely in terms of data technology and for retrieval purposes,
it being possible for the input data relating to selected large components to be retrieved by further providers using the computer, and
it being possible for an offer to be created in each case on the basis of the retrieved or pre-processed data by all providers and for this offer to be transmitted to the potential customer.

2. System according to claim 1, wherein the input data can be retrieved by means of a data processing device connected to the intranet of the first provider.

3. System according to claim 1, wherein the input data can be analysed by means of the data processing device, and possibly at least one large component matching the inquiry can be selected.

4. System according to claim 1, wherein the product data associated with the respective large component can be passed to a receiver system provided for the purpose of creating an offer.

5. System according to claim 1, wherein the customer data associated with the respective potential customer can be passed to the receiver system provided for the purpose of creating the offer.

6. System according to claim 1, wherein the offer can be created automatically by the receiver system.

7. System according to claim 1, wherein the offer of a system associated with the potential customers can be passed to a sales unit of at least one of the providers.

8. System according to claim 1, wherein a created offer can be passed to the potential customer.

9. System according to claim 1, wherein the inquiry data, the customer data and/or the offer data can be stored for statistical evaluation purposes.

10. System according to claim 1, wherein it is possible to provide access rights to the inquiry/offer webpage for customers and/or for providers.

11. System according to claim 1, wherein the input data can first be released before they can be retrieved by a potential customer.

12. System according to claim 1, wherein a fee for the provision of the inquiry/offer webpage can be imposed on the potential customer online or it may be requested that an agreement be made to pay this fee.

13. System for the purpose of handling an inquiry/offer process for large components in electrical engineering,
an inquiry/offer webpage being set up on an Internet server of a potential provider,
input data relating to a large component being input into an input mask of the webpage by potential customers,
the input data being saved in terms of data technology by the Internet server and being made available for retrieval purposes, and
the input data relating to selected large components being retrieved by providers using their computers and made available to the respective provider for processing purposes, in each case an offer being created by the providers, and this offer being transmitted to the potential customer.

14. System according to claim 2, wherein the input data can be analysed by means of the data processing device, and possibly at least one large component matching the inquiry can be selected.

15. System according to claim 2, wherein the product data associated with the respective large component can be passed to a receiver system provided for the purpose of creating an offer.

16. System according to claim 3, wherein the product data associated with the respective large component can be passed to a receiver system provided for the purpose of creating an offer.

17. System according to claim 2, wherein the customer data associated with the respective potential customer can be passed to the receiver system provided for the purpose of creating the offer.

18. System according to claim 3, wherein the customer data associated with the respective potential customer can be passed to the receiver system provided for the purpose of creating the offer.

19. System according to claim 4, wherein the customer data associated with the respective potential customer can be passed to the receiver system provided for the purpose of creating the offer.

20. System according to claim 2, wherein the offer can be created automatically by the receiver system.
